(19) United States
(12) Patent Application Publication
(10) Pub. No.: US 2025/0005356 A1
(43) Pub. Date: Jan. 2, 2025

(54) OBJECT OPERATING METHOD AND APPARATUS, COMPUTER DEVICE, AND COMPUTER STORAGE MEDIUM

(71) Applicants: Beijing BOE Technology Development Co., Ltd., Beijing (CN); BOE Technology Group Co., Ltd., Beijing (CN)

(72) Inventors: Shuqi WEI, Beijing (CN); Pengfei ZHANG, Beijing (CN); Chuqian ZHONG, Beijing (CN)

(21) Appl. No.: 18/707,804

(22) PCT Filed: Jul. 31, 2023
(86) PCT No.: PCT/CN2023/110289

§ 371 Date: May 6, 2024

(30) Foreign Application Priority Data
Sep. 21, 2022 (CN) 202211153843.6

(51) Int. Cl. G06N 3/08; G06T 5/60; G06V 10/82; G10L 17/18

(52) U.S. Cl. CPC G06N 3/08; G06T 5/60; G06V 10/82; G10L 17/18; G06T 2207/20084

(57) ABSTRACT

Provided is an object operating method, includes: acquiring an object to be operated; inputting the object to be operated into a target model, wherein the target model is a trained neural network model and at least one set of parameters in the target model is acquired in a predetermined manner, and the target model is configured to carry out a recognition operation or a processing operation on the object to be operated; and acquiring an operation result output by the target model; wherein the predetermined manner includes: acquiring a collection of sample parameters corresponding to a first set of parameters of the target model, performing a plurality of iteration processing on the collection of sample parameters; acquiring a target set of parameters based on the collection of sample parameters subjected to the plurality of iteration processing; and determining the target set of parameters as the first set of parameters.

This application is a U.S. national stage of international application No. PCT/CN2023/110289, filed on Jul. 31, 2023, which claims priority to Chinese patent application No. 202211153843.6, filed on Sep. 21, 2022, for the invention titled “OBJECT OPERATION METHOD AND APPARATUS, COMPUTER DEVICE, AND COMPUTER STORAGE MEDIUM”, the entire contents of which are incorporated herein by reference.

### TECHNICAL FIELD

The present application relates to the field of data processing technologies and, in particular, to an object operating method and apparatus, a computer device, and a computer storage medium.

### BACKGROUND

An object operating method is used to perform various operations on an object. The object operating method is used to perform processing operations and recognition operations on various objects such as images, sounds, and signals to obtain operation results.

### SUMMARY

Embodiments of the present application provide an object operating method and apparatus, a computer device, and a computer storage medium. The technical solutions are as follows.

According to some embodiments of the present application, an object operating method is provided. The method is applicable to a server or a terminal, and includes:
acquiring an object to be operated, wherein the object to be operated includes at least one types of image data, sound data, or signal data;
inputting the object to be operated into a target model, wherein the target model is a trained neural network model and at least one set of parameters in the target model is acquired in a predetermined manner; and the target model is configured to carry out a recognition operation or a processing operation on the object to be operated; in a case that the object to be operated is the image data, the processing operation on the image data carried out by the target model comprises at least one of repairing, beautifying, or adjusting the image data, and the recognition operation on the image data carried out by the target model comprises at least one of recognizing objects, characters, or text in the image data; in a case that the object to be operated is the sound data, the processing operation on the sound data carried out by the target model comprises at least one of adjusting or editing the sound data, and the recognition operation on the sound data carried out by the target model comprises at least one of recognizing voiceprint information or language information in the sound data;
acquiring an operation result output by the target model;
wherein the predetermined manner includes: acquiring a collection of sample parameters corresponding to a first set of parameters of the target model, the collection of sample parameters including a plurality of sets of sample parameters; performing a plurality of iteration processing on the collection of sample parameters; acquiring a target set of parameters based on the collection of sample parameters subjected to the plurality of iteration processing; and determining the target set of parameters as the first set of parameters, one iterative processing including: acquiring four pending sets of parameters corresponding to two sets of sample parameters in the collection of sample parameters in a plurality of optimization directions, and replacing one of the two sets of sample parameters by a pending set of parameters with the smallest loss value among the four pending sets of parameters.

In some embodiments, prior to acquiring the object to be operated, performing the plurality of iteration processing on the collection of sample parameters and acquiring the target set of parameters based on the collection of sample parameters after the plurality of iteration processing includes:
acquiring a collection of iterated sample parameters by performing iteration processing on the collection of sample parameters;
performing next iteration processing on the collection of iterated sample parameters in response to not satisfying a preset iteration termination condition; and
acquiring the target set of parameters based on the collection of iterated sample parameters in response to satisfying the preset iteration termination condition.

In some embodiments, the collection of sample parameters includes m+1 sets of sample parameters, referring as wₙ, wₙ₊₁, wₙ₊₂ . . . wₙ₊ₘ, n being an integer greater than or equal to 0, and m being an integer greater than 2; and
acquiring the four pending sets of parameters corresponding to the two sets of sample parameters in the collection of sample parameters in the plurality of optimization directions includes:
acquiring the four pending sets of parameters by means of preset formulas, the preset formulas including:

wₓ=wₙ₊₁+s*(wₙ₊₁−wₙ), s being greater than 0;

wₓ₊₁=wₙ₊₁+2s*(wₙ₊₁−wₙ);

wₓ₊₂=wₙ₊₁+u*(wₙ−wₙ₊₁), u being greater than 0 and less than 1; and

wₓ₊₃=wₙ+s*(wₙ−wₙ₊₁);
where wₓ, wₓ₊₂, wₓ₊₃, and wₓ₊₄ are the four pending sets of parameters, x is an integer greater than 0, and s and u are preset coefficients.

In some embodiments, replacing one of the two sets of sample parameters by the pending set of parameters with the smallest loss value among the four pending sets of parameters includes:
removing wₙ from the collection of sample parameters and determining wₓ₊₁ as wₙ₊ₘ₊₁ of the collection of sample parameters in response to satisfying a first formula Lₙ>Lₓ, Lₓ≥Lₓ₊₁;
removing wₙ from the collection of sample parameters and determining wₓ as wₙ₊ₘ₊₁ of the collection of sample parameters in response to satisfying a second formula Lₙ>Lₓ, Lₓ<Lₓ₊₁;
removing wₙ from the collection of sample parameters and determining wₓ₊₂ as wₙ₊ₘ₊₁ of the collection of sample parameters in response to satisfying a third formula Lₙ≤Lₓ, Lₓ>Lₓ₊₂; and
removing wₙ from the collection of sample parameters and determining wₓ₊₃ as wₙ₊ₘ₊₁ of the collection of sample parameters in response to not satisfying the first formula, the second formula, or the third formula;
where Ln is a loss value for wₙ, Lₓ is a loss value for wₓ, Lₓ₊₁ is a loss value for wₓ₊₁, and Lₓ₊₂ is a loss value for wₓ₊₂.

In some embodiments, acquiring the target set of parameters based on the collection of iterated sample parameters in response to satisfying the preset iteration termination condition includes:
determining a first set of sample parameters with the smallest loss value in the collection of iterated sample parameters in response to satisfying the preset iteration termination condition;
acquiring a mean set of sample parameters of the plurality of sets of sample parameters in the collection of iterated sample parameters;
determining the first set of sample parameters as the target set of sample parameters in response to the loss value of the first set of sample parameters being less than a loss value of the mean set of sample parameters; and
determining the mean set of sample parameters as the target set of sample parameters in response to the loss value of the first set of sample parameters being greater than the loss value of the mean set of sample parameters.

In some embodiments, after acquiring the collection of iterated sample parameters, the method further includes:
determining that the preset iteration termination condition is satisfied in response to a number of times of the iteration processing as performed reaching a specified value; and
determining that the preset iteration termination condition is not satisfied in response to the number of times of the iteration processing as performed not reaching the specified value.

In some embodiments, after acquiring the collection of iterated sample parameters, the method further includes:
acquiring a pending set of sample parameters corresponding to the collection of iterated sample parameters, the pending set of sample parameters being a mean set of sample parameters of the plurality of sets of sample parameters in the collection of sample parameters or the pending set of sample parameters being a set of sample parameters with the smallest loss value in the collection of sample parameters;
determining that the preset iteration termination condition is satisfied in response to a loss value of the pending set of sample parameters being less than or equal to a specified loss value; and
determining that the preset iteration termination condition is not satisfied in response to the loss value of the pending set of sample parameters being greater than the specified loss value.

In some embodiments, acquiring the target set of parameters based on the collection of iterated sample parameters in response to satisfying the preset iteration termination condition includes:
acquiring a mean set of sample parameters of the plurality of sets of sample parameters in the collection of iterated sample parameters in response to satisfying the preset iteration termination condition; and
determining the mean set of sample parameters as the target set of sample parameters.

In some embodiments, acquiring the target set of parameters based on the collection of iterated sample parameters in response to satisfying the preset iteration termination condition includes:
acquiring a first set of sample parameters with the smallest loss value in the collection of iterated sample parameters in response to satisfying the preset iteration termination condition; and
determining the first set of sample parameters as the target set of sample parameters.

In some embodiments, prior to acquiring the four pending sets of parameters by means of the preset formulas, the method further includes:
acquiring wₙ, wₙ₊₁, wₙ₊₂, and wₙ₊₃ corresponding to the first set of parameters in sequence.

According to some embodiments of the present application, a computer device is provided. The computer device includes a processor and a memory storing at least one instruction, at least one segment of a program, a code set, or a set of instructions therein, wherein the processor, when loading and executing the at least one instruction, the at least one segment of a program, and the code set, or set of instructions, is caused to perform the object operating method as described above.

According to some embodiments of the present application, a non-transitory computer storage medium is provided. The computer storage medium stores at least one instruction, at least one segment of a program, a code set, or a set of instructions therein. The at least one instruction, the at least one segment of a program, and the code set, or set of instructions, when loaded and executed by a processor, causes the process to perform the object operating method as described above.

### BRIEF DESCRIPTION OF DRAWINGS

For clearer descriptions of the technical solutions in the embodiments of the present disclosure, the following briefly introduces the accompanying drawings required for describing the embodiments. Apparently, the accompanying drawings in the following description show merely some embodiments of the present disclosure, and persons of ordinary skill in the art may still derive other drawings from these accompanying drawings without creative efforts

FIG. 1 is a schematic diagram of an object operating system according to some embodiments of the present application;

FIG. 2 is a flowchart of an object operating method according to some embodiments of the present application;

FIG. 3 is a flowchart of another object operating method according to some embodiments of the present application;

FIG. 4 is a flowchart of iteration processing according to some embodiments of the present application;

FIG. 5 illustrates a flowchart of acquiring a target set of parameters based on a collection of iterated sample parameters according to some embodiments of the present application;

FIG. 6 is a two-dimensional contour plot of an iterative process for parameter optimization according to some embodiments of the present application; and

FIG. 7 is a block diagram of a structure of an object operating apparatus according to some embodiments of the present application.

Definite embodiments of the present application have been shown by means of the above-described accompanying drawings, which will be described in greater detail later. These accompanying drawings and textual descriptions are not intended to limit in any way the conception scope of the present application, but rather to illustrate the concepts of the present application for those skilled in the art by reference to particular embodiments.

### DETAILED DESCRIPTION

For clearer descriptions of the objectives, technical solutions, and advantages of the present disclosure, embodiments of the present disclosure are described in detail hereinafter with reference to the accompanying drawings.

In some object operating methods, a similarity between an object to be operated and an object in an object library is compared, which includes a plurality of objects and an operation result corresponding to each object. If there exists an object in the object library whose similarity to the object to be operated is greater than a specified value, the operation result corresponding to the object in the object library is determined as the operation result of the object to be operated. Exemplarily, the object to be operated is a picture, and the operation result corresponding to the picture in the object library is the classification result corresponding to the content of the picture.

However, the processing success rate of the above object operating method depends on the capacity of the object library, resulting in low flexibility of this object operating method.

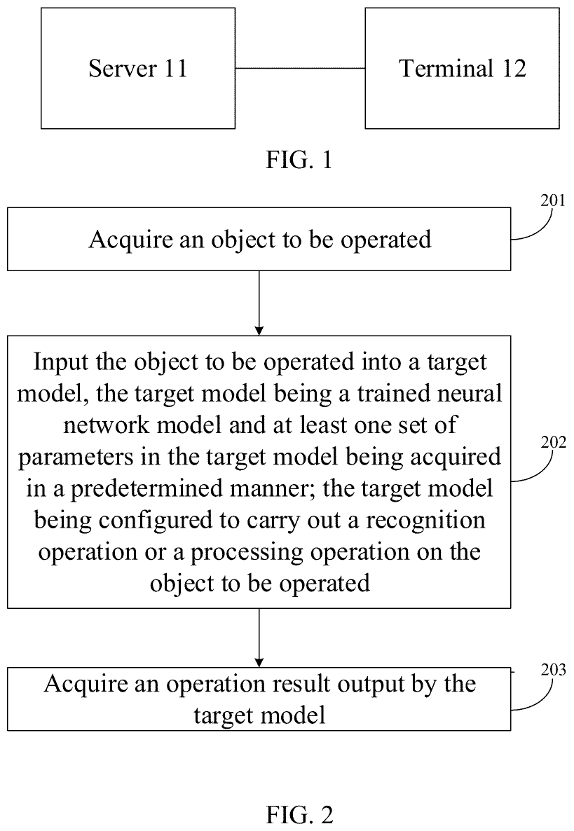

An object operating method according to some embodiments of the present application is applied to an object operating system. As shown in FIG. 1, FIG. 1 is a schematic diagram of an object operating system according to some embodiments of the present application. The object operating system includes at least one of a server and a terminal (FIG. 1 is an example of the object operating system including a server and a terminal but is not limiting in this regard). The object operating system is configured to process an object to be operated. When the object operating system includes a server 11 and a terminal 12, a wired connection and/or a wireless connection is established between the server 11 and the terminal 12.

The server 11 includes one server, or includes a cluster of servers. The terminal 12 includes a desktop computer, a laptop computer, a smartphone, and other smart wearable devices, among others.

The object operating method according to the embodiments of the present application includes a model optimization process and an object manipulation process, both of which are implemented in the server 11, or, both of which are implemented in the terminal 12, or, one of which is implemented in the server 11 and the other is implemented in the terminal 12. In some embodiment, the model optimization process of the two processes is implemented in the server 11 and the object manipulation process is implemented in the terminal 12, which is not limited in the embodiments of the present application.

A target model involved in the embodiments of the present application is a trained neural network model. The neural network (NN) model is a complex network model formed by a large number of processing units (called neurons) extensively interconnected with each other, which reflects many of the basic features of human brain functions, and is a highly complex nonlinear dynamical learning system. With massively parallel, distributed storage and processing, self-organization, self-adaptation and self-learning capabilities, the neural network model is suitable for dealing with information processing problems that require simultaneous consideration of many factors and conditions, imprecision and ambiguity.

The neural network model is trained before the application so as to improve the accuracy of the neural network model in the application. And in the process of training the neural network model, sets of parameters in the neural network model are optimized. The common optimization method at present is to use a back-propagation algorithm to calculate the gradient of the parameters. In the method, a model prediction value is obtained through forward propagation, and then the gradient of the parameters is obtained through the back-propagation algorithm of the error, and then the parameters are updated to a descent direction and a ratio indicated by the gradient, and then iterated step by step to obtain optimized parameters.

However, since the above backpropagation algorithm requires the computation of gradient, which consumes a lot of computational resources, this has a serious impact on the training speed of the model and higher requirements for the computing power of the equipment used to train the model, which all constrain the application of the neural network model in the object operating method.

In the object operating method according to the embodiments of the present application, by acquiring four pending sets of parameters corresponding to two sets of sample parameters in a collection of sample parameters in a plurality of optimization directions and replacing one of the two sets of sample parameters by a pending set of parameters with the smallest loss value among the four pending sets of parameters. In this way, the iteration of the set of parameters is realized. This forward propagation approach eliminates the need to calculate the gradient, thus reducing the amount of computation in the parameter optimization process. On the one hand, this improves the training speed of the model, and on the other hand, it reduces the high requirements for the computing power of the equipment for training the model, so that the neural network model is applied to the object operating method.

FIG. 2 is a flowchart of an object operating method according to some embodiments of the present application. The object operating method includes the following steps.

In step 201, an object to be operated is acquired.

In step 202, the object to be operated is input into a target model. the target model is a trained neural network model, and at least one set of parameters in the target model is acquired in a predetermined manner, and the target model is configured to perform a recognition operation or a processing operation on the object to be operated.

In step 203, an operation result output by the target model is acquired.

The predetermined method includes: acquiring a collection of sample parameters corresponding to a first set of parameters of the target model, the collection of sample parameters including a plurality of sets of sample parameters; performing a plurality of iteration processing on the collection of sample parameters; acquiring a target set of parameters based on the collection of sample parameters subjected to the plurality of iteration processing; and determining the target set of parameters as the first set of parameters, one iterative processing including: acquiring four pending sets of parameters corresponding to two sets of sample parameters in the collection of sample parameters in a plurality of optimization directions, and replacing one of the two sets of sample parameters by a pending set of parameters with the smallest loss value among the four pending sets of parameters.

In summary, in the object operating method according to the embodiments of the present application, an object to be operated is input into a target model, and the target model processes the object to be operated to output an operation result. Since the target model is a trained neural network model without relying on an object library, the problem that the processing success rate of the object operating method in the related art depends on the size of the object library and thus results in a lower flexibility of the object operating method is solved, realizing the effect of improving the flexibility of the object operating method.

In addition, since at least one set of parameters in the above target model is acquired in a predetermined manner, and the predetermined manner is to optimize the set of parameters by means of forward propagation, which reduces the computational amount of the parameter optimization, improves the speed of the parameter optimization, and thus makes it possible to acquire the above target model more quickly for the processing of the object to be processed. In other words, the processing speed of the object to be operated is improved on the whole.

It is to be noted that in the object operating method according to the embodiments of the present application, the target model is configured to perform a recognition operation or a processing operation on the object to be operated. The recognition operation refers to an operation of recognize the object to be operated to obtain a recognition result, and the processing operation refers to an operation of processing part or all of the data of the object to be operated to obtain a processing object (the object to be operated is various types of data for the subject of execution of the object operating method, and the processing operation of the object to be operated includes a processing operation of the data). Specifically, the object to be operated is various types of data such as images, sounds, and signals, etc., and for different types of the object to be operated, the results of the recognition operation and the processing operation carried out by the target model are different. In some embodiment, in the case that the object to be operated is image data, the processing operation on the image data carried out by the target model includes repairing, beautifying, and adjusting the image data, etc., and the recognition operation on the image data carried out by the target model includes recognizing objects, characters, text, etc. in the image data. In the case that the object to be operated is sound data, the processing operation on the sound data carried out by the target model includes adjusting and editing the sound data, etc., and the recognition operation on the sound data carried out by the target model includes recognizing voiceprint information, language information (such as converting sounds into text), etc. in the sound data. In the case that the object to be operated is signal data, the processing operation and the recognition operation on the signal data include processing and recognizing the signal data.

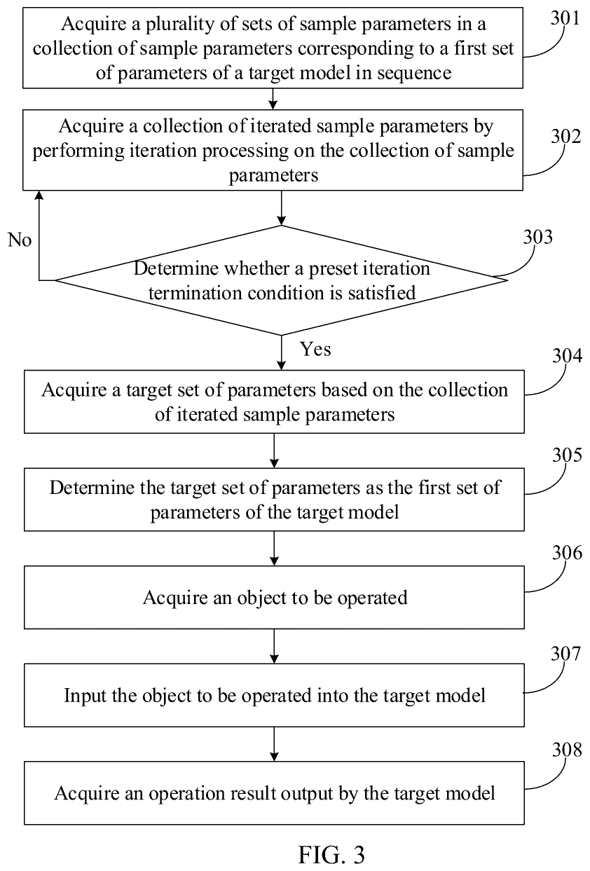

FIG. 3 is a flowchart of another object operating method according to some embodiments of the present application. The embodiments of the present application are illustrated with the method being applied in a server. The object operating method includes the following steps.

In step 301, a plurality of sets of sample parameters in a collection of sample parameters corresponding to a first set of parameters of a target model is acquired in sequence.

The object operating method according to the embodiments of the present application includes a process of optimizing a set of parameters in the target model and a process of performing object manipulation through the target model. The target model includes at least one set of parameters. The embodiments of the present application are illustrated by optimizing a first set of parameters therein.

In the process of optimizing the first set of parameters, the server acquires a plurality of sets of sample parameters in the collection of sample parameters corresponding to the first set of parameters in sequence. Based on the order of acquisition, the plurality of sets of sample parameters also have an order accordingly, which plays a corresponding role in the subsequent iteration processing.

In some embodiments, the collection of sample parameters includes 4 sets of sample parameters, referring as wₙ, wₙ₊₁, wₙ₊₂, and wₙ₊₃, with n being an integer greater than 0. In some embodiments of the present application, an initial collection of sample parameters is acquired by random initialization. For example, the sets of parameters are initialized by Gaussian distribution data to obtain the initial collection of sample parameters.

In step 302, iteration processing is performed on the collection of sample parameters to obtain a collection of iterated sample parameters.

The iterative processing is a kind of processing for optimizing the sets of sample parameters, and the iterative processing is configured to make the plurality of sets of sample parameters in the collection of sample parameters have a smaller loss value overall.

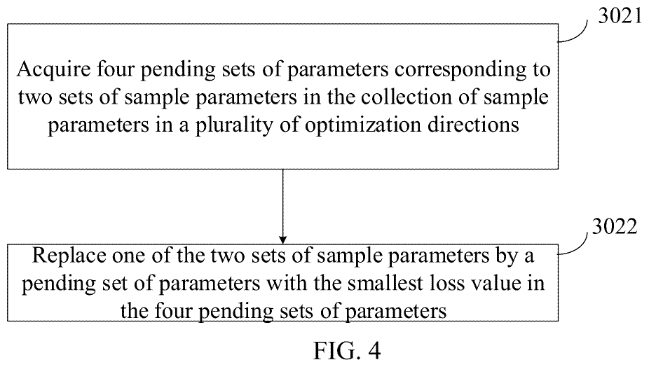

In some embodiments, as shown in FIG. 4, FIG. 4 is a flowchart of a method of iteration processing according to some embodiments of the present application. One iteration processing includes the following steps.

In sub-step 3021, four pending sets of parameters corresponding to two sets of sample parameters in the collection of sample parameters in a plurality of optimization directions are acquired.

The server selects two sets of sample parameters in the collection of sample parameters each time it performs iterative processing and acquires four pending sets of parameters for the two sets of sample parameters in a plurality of optimization directions. This is a type of forward propagation optimization. The server selects the first two sets of sample parameters, i.e., the first and the second set of sample parameters in order, based on the order of the set of sample parameters in the collection of sample parameters.

In some embodiments, the collection of sample parameters includes m+1 sets of sample parameters, referring as wₙ, wₙ₊₁, wₙ₊₂ . . . wₙ₊ₘ, n being an integer greater than or equal to 0, and m being an integer greater than 2.

The server acquires the four pending sets of parameters by a preset formula, which are the four pending sets of parameters corresponding to the two sets of parameters wₙ and wₙ₊₁ in the plurality of optimization directions.

The preset formula includes:

wₓ=wₙ₊₁+s*(wₙ₊₁−wₙ), s being greater than 0;

wₓ₊₁=wₙ₊₁+2s*(wₙ₊₁−wₙ);

wₓ₊₂=wₙ₊₁+u*(wₙ−wₙ₊₁), u being greater than 0 and less than 1; and

wₓ₊₃=wₙ+s*(wₙ−wₙ₊₁);
where wₓ, wₓ₊₂, wₓ₊₃, and wₓ₊₄ are the four pending sets of parameters, x is an integer greater than 0, and s and u are preset coefficients.

In sub-step 3022, one of the two sets of sample parameters is replaced by a pending set of parameters with the smallest loss value of the four pending sets of parameters.

In implementing the sub-step 3022, one way includes:
in response to satisfying a first formula Lₙ>Lₓ, Lₓ≥Lₓ₊₁, removing wₙ from the collection of sample parameters and determining wₓ₊₁ as wₙ₊ₘ₊₁ of the collection of sample parameters;
in response to satisfying a second equation Lₙ>Lₓ, Lₓ<Lₓ₊₁, removing wₙ from the collection of sample parameters and determining wₓ as wₙ₊ₘ₊₁ of the collection of sample parameters;
in response to satisfying a third equation Lₙ≤Lₓ, Lₓ>Lₓ₊₂, removing wₙ from the collection of sample parameters and determining wₓ₊₂ as wₙ₊ₘ₊₁ of the collection of sample parameters; and
in response to none of the first formula, the second formula the third formula being satisfied, removing wₙ from the collection of sample parameters and determining wₓ₊₃ as wₙ₊ₘ₊₁ of the collection of sample parameters;
where Lₙ is a loss value of wₙ, Lₓ is a loss value of wₓ, Lₓ₊₁ is a loss value of wₓ₊₁, and Lₓ₊₂ is a loss value of wₓ₊₂.

It should be noted that since the four sets of conditions above are mutually exclusive in their application, in most cases, four judgments and the corresponding computations are not required. In most cases, only the first two judgments and the corresponding computations are required.

The loss value Lₓ₊ᵢ=loss(yₜᵣᵤₜₕ,ƒ(s;wₓ₊₁)) i=0, 1, 2, 3, s is an input to the target model, yₜᵣᵤₜₕ is a true value corresponding to the input s, and ƒ(s;wₓ₊ᵢ) is a function corresponding to the target model.

In step 303, it is determined whether a preset iteration termination condition is satisfied. When the preset iteration termination condition is satisfied, step 304 is performed. When the preset iteration termination condition is not satisfied, step 302 is performed.

The server determines whether the preset iteration termination condition is satisfied after each iteration processing is completed.

In some embodiments of the present application, a variety of iteration termination conditions exists. The server terminates the iteration processing when one of the iteration termination conditions is satisfied.

The first method for determining the iteration termination condition includes:
1) in response to the number of times the iteration processing as performed reaching a specified value, determining that the preset iteration termination condition is satisfied; and
2) in response to the number of times the iteration processing as performed not reaching the specified value, determining that the preset iteration termination condition is not satisfied.

In this case, the iteration termination condition is that the number of times the iteration processing as performed reaches a specified value, which is set in advance.

The second method for determining the iteration termination condition includes the following.

1) A pending set of sample parameters corresponding to the collection of iterated sample parameters is acquired.

The pending set of sample parameters is a mean set of sample parameters of the plurality of sets of sample parameters in the collection of sample parameters or a set of sample parameters with the smallest loss value in the collection of sample parameters.

The mean set of sample parameters is a mean of the plurality of sets of sample parameters in the collection of iterated sample parameters, which is an arithmetic mean or other type of mean, which is not limited in the embodiments of the present application.

A loss value of the mean set of sample parameters l̅=Loss[yₜᵣᵤₜₕ,ƒ(s;w̅)];

A loss value of the set of sample parameters wi with the smallest loss value in the collection of sample parameters is:

l=minLoss[yₜᵣᵤₜₕ,ƒ(s;wᵢ)];

The server determines any one of the mean set of sample parameters and the set of sample parameters with the smallest loss value as the pending set of sample parameters, or, determines one, which has a smaller loss value, of the mean set of sample parameters and the set of sample parameters with the smallest loss value as the pending set of sample parameters, which is not limited in the embodiments of the present application.

2) In response to a loss value of the pending set of sample parameters being less than or equal to a specified loss value, it is determined that the preset iteration termination condition is satisfied.

When the loss value of the pending set of sample parameters is less than or equal to the specified loss value, it indicates that the pending set of sample parameters satisfies the condition, and the server determines that the preset iteration termination condition is satisfied.

3) In response to the loss value of the pending set of sample parameters being greater than the specified loss value, it is determined that the preset iteration termination condition is not satisfied.

When the loss value of the pending set of sample parameters is greater than the specified loss value, it indicates that the pending set of sample parameters does not satisfy the condition, and the server determines that the preset iteration termination condition is not satisfied.

When the preset iteration termination condition has not been reached, the server re-executes the step 302 for the next iteration processing.

In step 304, a target set of parameters is acquired based on the collection of iterated sample parameters.

Upon reaching the preset iteration termination condition, the server acquires the target set of parameters based on the collection of iterated sample parameters.

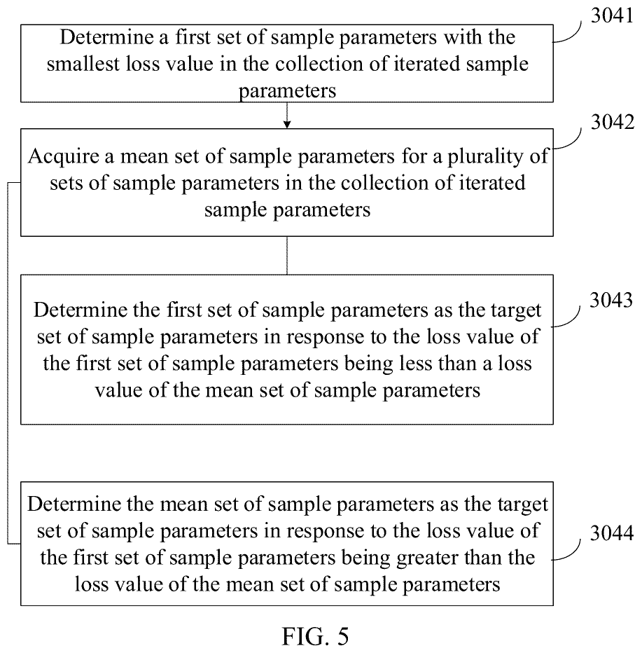

In some embodiments of the present application, the server acquires the target set of parameters based on the collection of iterated sample parameters in a variety of ways. In some embodiments, as shown in FIG. 5, FIG. 5 illustrates a flowchart of a process of acquiring a target set of parameters based on a collection of iterated sample parameters in some embodiments of the present application. The process of acquiring a target set of parameters based on a collection of iterated sample parameters includes the following steps.

In sub-step 3041, a first set of sample parameters with the smallest loss value in the collection of iterated sample parameters is determined.

The first set of sample parameters with the smallest loss value is acquired with reference to the above sub-step 303, which is not repeated here in the embodiments of the present application.

In sub-step 3042, a mean set of sample parameters for a plurality of sets of sample parameters in the collection of iterated sample parameters is acquired.

The first set of sample parameters with the smallest loss value is acquired with reference to the above sub-step 303, which is not repeated here in the embodiments of the present application.

In sub-step 3043, in response to the loss value of the first set of sample parameters being less than a loss value of the mean set of sample parameters, the first set of sample parameters is determined as the target set of sample parameters.

In sub-step 3044, in response to the loss value of the first set of sample parameters being greater than the loss value of the mean set of sample parameters, the mean set of sample parameters is determined as the target set of sample parameters.

That is, the server determines one, with a smaller loss value, of the first set of sample parameters and the mean set of sample parameters as the target set of sample parameters.

Another process of acquiring a target set of parameters based on a collection of iterated sample parameters includes the following.

1) A first set of sample parameters with the smallest loss value in the collection of iterated sample parameters is acquired.

The first set of sample parameters with the smallest loss value is acquired with reference to the above sub-step 303, which is not repeated here in the embodiments of the present application.

2) The first set of sample parameters is determined as the target set of sample parameters.

In this approach, the server determines the first set of sample parameters as the target set of sample parameters.

In step 305, the target set of parameters is determined as the first set of parameters of the target model.

The target set of sample parameters is a set of optimized sample parameters, and the server determines the target set of parameters as the first set of parameters of the target model for optimizing the parameters in the target model.

By the end of the step 305, the optimization process of the target model is completed, and the server optimizes the set of parameters in the target model by the method shown in the steps 301 to 305.

In step 306, an object to be operated is acquired.

The object to be operated is various data such as image data, sound data, and signal data.

It should be noted that the type of the object to be operated is a type corresponding to the target model, and if an object that the target model handles has been determined, the server also acquires an object to be operated corresponding to the type in this step.

In some embodiments, if the target model is a model for recognizing images, the object to be operated acquired in the step 306 is image data. If the target model is a model for processing sounds, the object to be operated acquired in the step 306 is sound data.

In step 307, the object to be operated is input into the target model.

Once the server inputs the object to be operated into the target model upon acquiring the object to be operated.

In step 308, an operation result output by the target model is acquired.

The server acquires the operation result output by the target model.

The object operating method according to the embodiments of the present application is applied in various models, such as LeNet network models, AlexNet network models, and the like.

The LeNet network model is originally proposed by Turing Award winner LeCun at the end of the 20th century. The input to the LeNet network model is a biplot of handwritten digits, which has a size of 32 pixels*32 pixels. The LeNet network model is composed of two convolutional layers, two pooling layers, and three fully-connected layers. After the last fully-connected layer, the sigmoid function operation is added that gives the network a nonlinear fitting capability. In some embodiments, the output of the LeNet network model is a 10-dimensional vector. The LeNet network model performs an image classification task, where each dimension vector of the 10-dimensional vector corresponds to one of the digits 0 to 9. When the value of the corresponding location in the vector is 1, it means that the classification of the image corresponds to the corresponding handwritten digit.

The convolutional and fully-connected layers of the LeNet network model have sets of parameters that is capable to be optimized. In the model training process in the related art, the back-propagation algorithm is commonly used to optimize the parameters. The back-propagation algorithm needs to use the chain rule (the chain rule is a derivation law in calculus, used to find the derivative of a composite function, which is a commonly used method in the derivation of the calculus) in the step of the gradient computation to solve the gradient, which is time-consuming and has a large amount of computational workload.

The object operating method according to the embodiments of the present application optimizes parameters by means of a forward propagation method and is applied to a LeNet network model to optimize a set of parameters in the LeNet network model. Because the method according to the embodiments of the present application has a small amount of computation and a shorter consuming time when optimizing a set of parameters, the optimization speed of the LeNet network model is improved, and it is convenient to quickly optimize the LeNet network model for image recognition.

The tasks performed by the AlexNet network model include image classification tasks. A color three-channel RGB image is taken as the input and the output is a multidimensional vector. Each dimension of the vector represents a specific category of the image, and hence the dimensionality of the vector is related to the number of categories of the image.

The AlexNet network model has 5 convolutional layers, as well as 3 pooling layers and 3 fully-connected layers. These convolutional and fully-connected layers also have a set of parameters that is capable to be optimized. In turn, this AlexNet network model optimizes a set of parameters by the method according to the embodiments of the present application.

In summary, in the object operating method according to the embodiments of the present application, an object to be operated is input into a target model, and the target model processes the object to be operated to output an operation result. Since the target model is a trained neural network model without relying on an object library, the problem that the processing success rate of the object operating method in the related art depends on the size of the object library and thus results in a lower flexibility of the object operating method is solved, realizing the effect of improving the flexibility of the object operating method.

In addition, since at least one set of parameters in the above target model is acquired in a predetermined manner, and the predetermined manner is to optimize the set of parameters by means of forward propagation, which reduces the computational amount of the parameter optimization, improves the speed of the parameter optimization, and thus makes it possible to acquire the above target model more quickly for the processing of the object to be processed. In other words, the processing speed of the object to be operated is improved on the whole.

The method of optimizing a set of parameters according to some embodiments of the present application is further described below.

In some embodiments, a set of parameters to be optimized in the target model is a two-dimensional parameter, which is denoted as [a,b]\hat{ }T, and it is preset that the number of set of sample parameters in the collection of sample parameters is 4,λ=1,ρ=0.5.

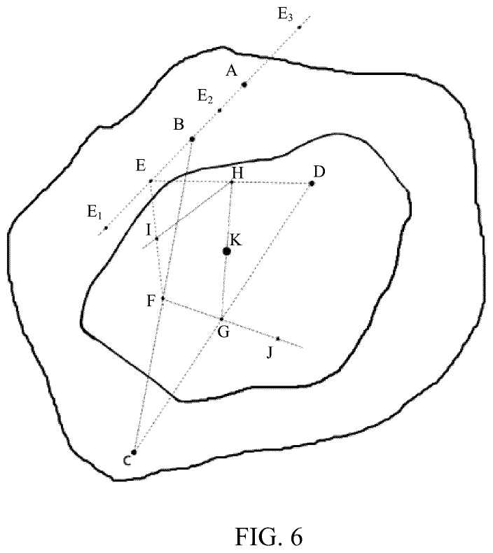

Referring to FIG. 6, FIG. 6 is a two-dimensional contour plot of an iterative process of parameter optimization according to some embodiments of the present application. The two circles of curves in FIG. 6 are contours of loss function values depicting the loss values at different parameter mapping locations. Points A, B, C, and D in the figure are four sets of sample parameters initially acquired, which constitute an initial collection of sample parameters.

The first iteration process includes the following.

Parameters indicated by points A and B are taken, and parameters w_{A}, w_{B} are applied, and 4 pending sets of sample parameters corresponding to w_{A}, w_{B} are calculated: w₀₁=w_{E}, w₀₂=w_{E}_{₁}, w₀₃=w_{E}_{₂}, w₀₄=w_{E}_{₃}. According to the magnitude of the loss value (the closer to the center, the smaller the loss value) corresponding to the position of each point in the graph, it is known that (l_{E}<l_{A})∩(l_{E}<l_{E}_{₁}) holds (lᵥ denotes the loss value, v is E, A, E1). The parameter w_{A} is removed from an alternative optimized set of parameters, and the parameter w_{E} is added to the collection of sample parameters.

At the end of the first iteration processing, sets of parameters corresponding to points B, C, D, and E exist in the collection of sample parameters.

The second iteration process takes points B and C. After the computation, a set of parameters w_{F} (the computation process is omitted here and w_{F} is assumed to be the set of parameters that is determined to satisfy the conditions involved in the step 302) is taken and added to the collection of sample parameters.

After many iterations, as can be seen in FIG. 6, the value of the loss function corresponding to the set of parameters is gradually approaching the point of minimal value.

When the parameter update reaches the iteration termination condition, it is assumed that points H, I, J, K exist in the collection of sample parameters.

It is assumed that wₖ (i.e., the set of parameters corresponding to point K) corresponds to the smallest loss value and that wₖ has a loss value 1.

Its average set of parameters is set to w_{z}:

$${w}_{Z} = \frac{1}{4} ( {w}_{H} + {w}_{I} + {w}_{J} + {w}_{K} ) ;$$

$$\overline{l} = Loss [ {y}_{truth} , f ( x ; {w}_{Z} ) ] ;$$

According to FIG. 6, it is seen that the location where point K is located is the minimal value point in the parameter space, and l<l̅ is established, so wₖ is taken as the optimal set of parameters, and wₖ is deployed in the target model.

In the object operating method according to the embodiments of the present application, the method for optimizing a set of parameters is a local minima point solving optimization method (which is also referred to as a weight wandering algorithm), which satisfied the same preconditions as the gradient descent method, i.e., a convex function that is derivable within a range of values of the function to be optimized.

Assuming that the optimal set of parameters is w*, then we have ƒ′(w*)=0, ƒ(w*)≤ƒ(w), in which ƒ(w) is the loss function. The gradient descent method requires computing the first order derivative of ƒ′(w) of the loss function ƒ(w). The value of ƒ′(w₀) is the original function gradient. The negative direction of the gradient is the direction where the function value decreases fastest. With the help of the first-order derivative, the gradient descent method makes the function value continue to decrease. When ƒ′(w)→0, then the function is judged to be close to the point of minimal value.

According to the definition of gradient:

$${f}^{′} ( w ) = \frac{f ( w + Δ w ) - f ( w )}{Δ w} Δ w \to 0 and Δ w > 0 ;$$

The gradient descent method controls the magnitude of parameter adjustment by the gradient value and the direction of parameter adjustment by the positive or negative gradient value. According to the definition of gradient, the positive and negative values of ƒ′(w) depend on the positive and negative values of ƒ(w+Δw)−ƒ(w). The gradient descent direction is the direction that makes ƒ(w+Δw)−ƒ(w)<0.

Whereas the method proposed in the present application will compute the value of the function ƒ(x), it is clear from the foregoing that the function to be optimized is a convex function and thus has and only has one set of parameters w* such that min ƒ(w)=ƒ(w*) holds, and distance(w,w*)∝ƒ(w)−ƒ(w*). The weighted wandering optimization algorithm continuously updates the function values of the parameters by initializing a plurality of sets of parameters so that the function value ƒ(w) keeps decreasing, i.e. ƒ(w)−ƒ(w*) continuously decreases, which in turn makes the value of distance(w,w*) continuously decreasing, converging to the local minima. As such, the optimization of the set of parameters in the objective function is achieved.

Apparatus embodiments according to the present disclosure are described hereinafter and are used to perform the method embodiments according to the present disclosure. For details not disclosed in the apparatus embodiments according to the present disclosure, reference is made to the method embodiments according to the present disclosure.

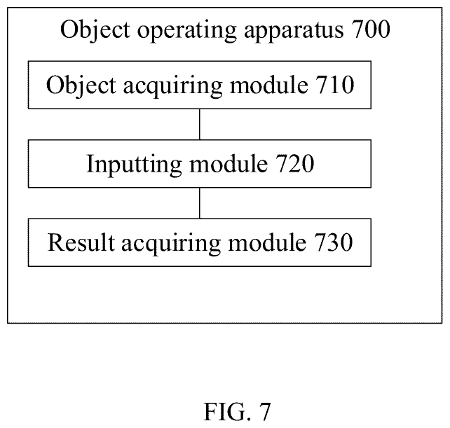

FIG. 7 is a block diagram of a structure of an object operating apparatus according to some embodiments of the present application. The object operating apparatus 700 includes:
an object acquiring module 710 configured to acquire an object to be operated;
an inputting module 720 configured to input the object to be operated into a target model, wherein the target model is a trained neural network model and at least one set of parameters in the target model is acquired in a predetermined manner, and the target model is configured to carry out a recognition operation or a processing operation on the object to be operated; and
a result acquiring module 730 configured to acquire an operation result output by the target model;
where the predetermined manner includes: acquiring a collection of sample parameters corresponding to a first set of parameters of the target model, the collection of sample parameters including a plurality of sets of sample parameters; performing a plurality of iteration processing on the collection of sample parameters; acquiring a target set of parameters based on the collection of sample parameters subjected to the plurality of iteration processing; and determining the target set of parameters as the first set of parameters, one iterative processing including: acquiring four pending sets of parameters corresponding to two sets of sample parameters in the collection of sample parameters in a plurality of optimization directions, and replacing one of the two sets of sample parameters by a pending set of parameters with the smallest loss value among the four pending sets of parameters.

In summary, in the object operating apparatus according to the embodiment of the present application, an object to be operated is input into a target model, and the target model processes the object to be operated to output an operation result. Since the target model is a trained neural network model without relying on an object library, the problem that the processing success rate of the object operating method in the related art depends on the size of the object library and thus results in a lower flexibility of the object operating method is solved, realizing the effect of improving the flexibility of the object operating method.

In addition, since at least one set of parameters in the above target model is acquired in a predetermined manner, and the predetermined manner is to optimize the set of parameters by means of forward propagation, which reduces the computational amount of the parameter optimization, improves the speed of the parameter optimization, and thus makes it possible to acquire the above target model more quickly for the processing of the object to be processed. In other words, the processing speed of the object to be operated is improved on the whole.

In some embodiments, the object operating apparatus further includes:
a first iteration module configured to acquire a collection of iterated sample parameters by performing iteration processing on the collection of sample parameters;
a second iteration module configured to perform next iteration processing on the collection of iterated sample parameters in response to not satisfying a preset iteration termination condition; and
a target acquiring module configured to acquire the target set of parameters based on the collection of iterated sample parameters in response to satisfying the preset iteration termination condition.

In some embodiments, the collection of sample parameters includes m+1 sets of sample parameters, referring as wₙ, wₙ₊₁, wₙ₊₂ . . . wₙ₊ₘ, n being an integer greater than or equal to 0, and m being an integer greater than 2.

The object operating apparatus further includes a pending parameter acquiring module configured to:
acquire four pending sets of parameters are means of preset formulas, the preset formulas including:

wₓ=wₙ₊₁+s*(wₙ₊₁−wₙ), s being greater than 0;

wₓ₊₁=wₙ₊₁+2s*(wₙ₊₁−wₙ);

wₓ₊₂=wₙ₊₁+u*(wₙ−wₙ₊₁), u being greater than 0 and less than 1; and

wₓ₊₃=wₙ+s*(wₙ−wₙ₊₁);
where wₓ, wₓ₊₂, wₓ₊₃, and wₓ₊₄ are the four pending sets of parameters, x is an integer greater than 0, and s and u are preset coefficients.

In some embodiments, the object operating apparatus further includes a parameter replacement module configured to:
remove wₙ from the collection of sample parameters and determine wₓ₊₁ as wₙ₊ₘ₊₁ of the collection of sample parameters in response to satisfying a first formula Lₙ>Lₓ, Lₓ≤Lₓ₊₁;
remove wₙ from the collection of sample parameters and determine wₓ as wₙ₊ₘ₊₁ of the collection of sample parameters in response to satisfying a second formula Lₙ>Lₓ, Lₓ<Lₓ+1;
remove wₙ from the collection of sample parameters and determine wₓ+2 as wₙ₊ₘ₊₁ of the collection of sample parameters in response to satisfying a third formula Lₙ≤Lₓ, Lₓ>Lₓ+2; and
remove wₙ from the collection of sample parameters and determine wₓ+3 as wₙ₊ₘ₊₁ of the collection of sample parameters in response to not satisfying the first formula, the second formula or the third formula;
where Lₙ is a loss value for wₙ, Lₓ is a loss value for wₓ, Lₓ₊₁ is a loss value for wₓ₊₁, and Lₓ₊₂ is a loss value for wₓ₊₂.

In some embodiments, the object operating apparatus further includes a first acquiring module for target set of parameters configured to:
determine a first set of sample parameters with the smallest loss value in the collection of iterated sample parameters in response to satisfying the preset iteration termination condition;
acquire a mean set of sample parameters of the plurality of sets of sample parameters in the collection of iterated sample parameters;
determine the first set of sample parameters as the target set of sample parameters in response to the loss value of the first set of sample parameters being less than a loss value of the mean set of sample parameters; and
determine the mean set of sample parameters as the target set of sample parameters in response to the loss value of the first set of sample parameters being greater than the loss value of the mean set of sample parameters.

In some embodiments, the object operating apparatus further includes a first iteration termination determination module configured to:
determine that the preset iteration termination condition is satisfied in response to a number of times of the iteration processing as performed reaching a specified value; and
determine that the preset iteration termination condition is not satisfied in response to the number of times of the iteration processing as performed not reaching the specified value.

In some embodiments, the object operating apparatus further includes a second iteration termination determination module configured to:
acquire a pending set of sample parameters corresponding to the collection of iterated sample parameters, the pending set of sample parameters being a mean set of sample parameters of the plurality of sets of sample parameters in the collection of sample parameters or the pending set of sample parameters being a set of sample parameters with the smallest loss value in the collection of sample parameters;
determine that the preset iteration termination condition is satisfied in response to a loss value of the pending set of sample parameters being less than or equal to a specified loss value; and
determine that the preset iteration termination condition is not satisfied in response to the loss value of the pending set of sample parameters being greater than the specified loss value.

In some embodiments, the object operating apparatus further includes a second acquiring module for target set of parameters configured to:
acquire a mean set of sample parameters of the plurality of sets of sample parameters in the collection of iterated sample parameters in response to satisfying the preset iteration termination condition; and
determine the mean set of sample parameters as the target set of sample parameters.

In some embodiments, the object operating apparatus further includes a third acquiring module for target set of parameters configured to:
acquire a first set of sample parameters with the smallest loss value in the collection of iterated sample parameters in response to satisfying the preset iteration termination condition; and
determine the first set of sample parameters as the target set of sample parameters.

In some embodiments, the object operating apparatus further includes a sequential acquiring module configured to:
acquire wₙ, wₙ₊₁, wₙ₊₂, and wₙ₊₃ corresponding to the first set of parameters in sequence.

In some embodiments, the objects to be operated include image data, sound data, and signal data.

According to another aspect of some embodiments of the present application, a computer device is provided. The computer device includes a processor and a memory. The memory stores at least one instruction, at least one segment of a program, a code set, or a set of instructions. The processor, when loading and executing the at least one instruction, the at least one segment of a program, the code set, or the set of instructions, is caused to perform the object operating method described above.

According to another aspect of embodiments of the present application, a non-transitory computer storage medium is provided. The computer storage medium has stored therein at least one instruction, at least one segment of a program, a code set, or a set of instructions. The at least one instruction, the at least one segment of a program, the code set, or the set of instructions, when loaded and executed by a processor, causes the process to perform the object operating method described above.

A computer program product or computer program is provided. The computer program product or computer program includes computer instructions that are stored in a computer-readable storage medium. The computer instructions, when read and executed by a processor of a computer device, cause the computer device to perform the method described above.

The term “and/or” in the present application is merely a description of an association relationship of the associated objects, indicating that three kinds of relationships exist, e.g., A and/or B, which are expressed as: A alone, both A and B, and B alone. In addition, the character “/” in this paper generally indicates that the associated objects before and after are in an “or” relationship.

The term “at least one of A and B” in the present application is merely a description of an association relationship of an associated object, and indicates that three relationships exist, for example, at least one of A and B is indicated as: the existence of A alone, the existence of both A and B, and the existence of B alone. Similarly, “at least one of A, B, and C” indicates that seven relationships exist, which are expressed as follows: A alone, B alone, C alone, both A and B, both A and C, both C and B, and both A, B, and C in seven cases. Similarly, “at least one of A, B, C and D” means that fifteen relationships exist, which are expressed as: A alone, B alone, C alone, D alone, both A and B, both A and C, both A and D, both C and B, both D and B, both C and D, both A and B, both A and B, both A and B, both D and C, both C and D, and both A, B and C. A, B and C at the same time, A, B and D at the same time, A, C and D at the same time, B, C and D at the same time, A, B, C and D at the same time, these are the fifteen cases.

In this application, the terms “first”, “second”, “third” are used for descriptive purposes only and are not to be construed as indicating or implying relative importance. The term “plural” refers to two or more, unless otherwise expressly limited.

In the several embodiments provided in the present application, it should be understood that the apparatuses and methods disclosed can be realized in other ways. For example, the apparatuses embodiments described above are merely schematic, e.g., the division of the units described, is merely a logical functional division, and the actual implementation is divided in other ways, e.g., multiple units or components are combined or are integrated into another system, or some features are ignored, or not implemented. Another point is that the mutual coupling or direct coupling or communication connection shown or discussed is an indirect coupling or communication connection through some interface, device or unit, which is electrical, mechanical or otherwise.

The units illustrated as separated components is or is not physically separated, and components displayed as units are or are not physical units, i.e., they are located in one place, or they are distributed to a plurality of network units. Some or all of these units are selected to fulfill the purpose of this embodiment scheme according to actual needs.

A person of ordinary skill in the art may understand that all or some of the steps for realizing the above embodiments are accomplished by hardware, or accomplished by a program that instructs the relevant hardware to do so, and the program is stored in a computer-readable storage medium, and that the storage medium referred to above is a read-only memory, a disk or a CD-ROM, or the like.

Described above are merely exemplary embodiments of the present disclosure, and are not intended to limit the present disclosure. Within the spirit and principles of the disclosure, any modifications, equivalent substitutions, improvements, and the like are within the protection scope of the present disclosure.

1. An object operating method, applicable to a server or a terminal, comprising:
acquiring an object to be operated, wherein the object to be operated is image data or sound data;
inputting the object to be operated into a target model, wherein the target model is a trained neural network model and at least one set of parameters in the target model is acquired in a predetermined manner, and the target model is configured to carry out a recognition operation or a processing operation on the object to be operated; in a case that the object to be operated is the image data, the processing operation on the image data carried out by the target model comprises at least one of repairing, beautifying, or adjusting the image data, and the recognition operation on the image data carried out by the target model comprises at least one of recognizing objects, characters, or text in the image data; in a case that the object to be operated is the sound data, the processing operation on the sound data carried out by the target model comprises at least one of adjusting or editing the sound data, and the recognition operation on the sound data carried out by the target model comprises at least one of recognizing voiceprint information or language information in the sound data; and
acquiring an operation result output by the target model;
wherein the predetermined manner comprises: acquiring a collection of sample parameters corresponding to a first set of parameters of the target model, the collection of sample parameters comprising a plurality of sets of sample parameters; performing a plurality of iteration processing on the collection of sample parameters; acquiring a target set of parameters based on the collection of sample parameters subjected to the plurality of iteration processing; and determining the target set of parameters as the first set of parameters, one iterative processing comprising: acquiring four pending sets of parameters corresponding to two sets of sample parameters in the collection of sample parameters in a plurality of optimization directions, and replacing one of the two sets of sample parameters by a pending set of parameters with the smallest loss value among the four pending sets of parameters.

2. The method according to claim 1, wherein prior to acquiring the object to be operated, performing the plurality of iteration processing on the collection of sample parameters and acquiring the target set of parameters based on the collection of sample parameters after the plurality of iteration processing comprises:
acquiring a collection of iterated sample parameters by performing iteration processing on the collection of sample parameters;
performing next iteration processing on the collection of iterated sample parameters in response to not satisfying a preset iteration termination condition; and
acquiring the target set of parameters based on the collection of iterated sample parameters in response to satisfying the preset iteration termination condition.

3. The method according to claim 1, wherein the collection of sample parameters comprises m+1 sets of sample parameters, referring as wₙ, wₙ₊₁, wₙ₊₂ wₙ₊₃ . . . wₙ₊ₘ, n being an integer greater than or equal to 0, and m being an integer greater than 2; and
acquiring the four pending sets of parameters corresponding to the two sets of sample parameters in the collection of sample parameters in the plurality of optimization directions comprises:
acquiring the four pending sets of parameters by means of preset formulas, the preset formulas comprising:
wₓ=wₙ₊₁+s*(wₙ₊₁−wₙ), s being greater than 0;
wₓ₊₁=wₙ₊₁+2s*(wₙ₊₁−wₙ);
wₓ₊₂=wₙ₊₁+u*(wₙ−wₙ₊₁), u being greater than 0 and less than 1; and
wₓ₊₃=wₙ+s*(wₙ−wₙ₊₁);
where wₓ, wₓ₊₁, wₓ₊₂, and wₓ₊₃ are the four pending sets of parameters, x is an integer greater than 0, and s and u are preset coefficients.

4. The method according to claim 3, wherein replacing one of the two sets of sample parameters by the pending set of parameters with the smallest loss value among the four pending sets of parameters comprises:
removing wₙ from the collection of sample parameters and determining wₓ₊₁ as wₙ₊ₘ₊₁ of the collection of sample parameters in response to satisfying a first formula Lₙ>Lₓ, Lₓ≥Lₓ₊₁;
removing wₙ from the collection of sample parameters and determining wₓ as wₙ₊ₘ₊₁ of the collection of sample parameters in response to satisfying a second formula Lₙ>Lₓ, Lₓ<Lₓ₊₁;
removing wₙ from the collection of sample parameters and determining wₓ₊₂ as wₙ₊ₘ₊₁ of the collection of sample parameters in response to satisfying a third formula Lₙ≤Lₓ, Lₓ>Lₓ₊₂; and
removing wₙ from the collection of sample parameters and determining wₓ₊₃ as wₙ₊ₘ₊₁ of the collection of sample parameters in response to not satisfying the first formula, the second formula or the third formula;
where Lₙ is a loss value for wₙ, Lₓ is a loss value for wₓ, Lₓ₊₁ is a loss value for wₓ₊₁, and Lₓ₊₂ is a loss value for wₓ₊₂.

5. The method according to claim 2, wherein acquiring the target set of parameters based on the collection of iterated sample parameters in response to satisfying the preset iteration termination condition comprises:
determining a first set of sample parameters with the smallest loss value in the collection of iterated sample parameters in response to satisfying the preset iteration termination condition;
acquiring a mean set of sample parameters of the plurality of sets of sample parameters in the collection of iterated sample parameters;
determining the first set of sample parameters as the target set of sample parameters in response to the loss value of the first set of sample parameters being less than a loss value of the mean set of sample parameters; and
determining the mean set of sample parameters as the target set of sample parameters in response to the loss value of the first set of sample parameters being greater than the loss value of the mean set of sample parameters.

6. The method according to claim 2, wherein after acquiring the collection of iterated sample parameters, the method further comprises:
determining that the preset iteration termination condition is satisfied in response to a number of times of the iteration processing as performed reaching a specified value; and
determining that the preset iteration termination condition is not satisfied in response to the number of times of the iteration processing as performed not reaching the specified value.

7. The method according to claim 2, wherein after acquiring the collection of iterated sample parameters, the method further comprises:
acquiring a pending set of sample parameters corresponding to the collection of iterated sample parameters, the pending set of sample parameters being a mean set of sample parameters of the plurality of sets of sample parameters in the collection of sample parameters or the pending set of sample parameters being a set of sample parameters with the smallest loss value in the collection of sample parameters;
determining that the preset iteration termination condition is satisfied in response to a loss value of the pending set of sample parameters being less than or equal to a specified loss value; and
determining that the preset iteration termination condition is not satisfied in response to the loss value of the pending set of sample parameters being greater than the specified loss value.

8. The method according to claim 2, wherein acquiring the target set of parameters based on the collection of iterated sample parameters in response to satisfying the preset iteration termination condition comprises:
acquiring a mean set of sample parameters of the plurality of sets of sample parameters in the collection of iterated sample parameters in response to satisfying the preset iteration termination condition; and
determining the mean set of sample parameters as the target set of sample parameters.

9. The method according to claim 2, wherein acquiring the target set of parameters based on the collection of iterated sample parameters in response to satisfying the preset iteration termination condition comprises:
acquiring a first set of sample parameters with the smallest loss value in the collection of iterated sample parameters in response to satisfying the preset iteration termination condition; and
determining the first set of sample parameters as the target set of sample parameters.

10. The method according to claim 3, wherein prior to acquiring the four pending sets of parameters by means of the preset formulas, the method further comprises:
acquiring wₙ, wₙ₊₁, wₙ₊₂, and wₙ₊₃ corresponding to the first set of parameters in sequence.

11-13. (canceled)

14. A computer device comprising a processor and a memory storing at least one instruction, at least one segment of a program, a code set, or a set of instructions therein, wherein the processor, when loading and executing the at least one instruction, the at least one segment of a program, and the code set, or set of instructions, is caused to perform:
acquiring an object to be operated, wherein the object to be operated is image data or sound data;
inputting the object to be operated into a target model, wherein the target model is a trained neural network model and at least one set of parameters in the target model is acquired in a predetermined manner, and the target model is configured to carry out a recognition operation or a processing operation on the object to be operated; in a case that the object to be operated is the image data, the processing operation on the image data carried out by the target model comprises at least one of repairing, beautifying, or adjusting the image data, and the recognition operation on the image data carried out by the target model comprises at least one of recognizing objects, characters, or text in the image data; in a case that the object to be operated is the sound data, the processing operation on the sound data carried out by the target model comprises at least one of adjusting or editing the sound data, and the recognition operation on the sound data carried out by the target model comprises at least one of recognizing voiceprint information or language information in the sound data;
acquiring an operation result output by the target model;
wherein the predetermined manner comprises: acquiring a collection of sample parameters corresponding to a first set of parameters of the target model, the collection of sample parameters comprising a plurality of sets of sample parameters; performing a plurality of iteration processing on the collection of sample parameters; acquiring a target set of parameters based on the collection of sample parameters subjected to the plurality of iteration processing; and determining the target set of parameters as the first set of parameters, one iterative processing comprising: acquiring four pending sets of parameters corresponding to two sets of sample parameters in the collection of sample parameters in a plurality of optimization directions, and replacing one of the two sets of sample parameters by a pending set of parameters with the smallest loss value among the four pending sets of parameters.

15. A non-transitory computer storage medium storing at least one instruction, at least one segment of a program, a code set, or a set of instructions therein, wherein the at least one instruction, the at least one segment of a program, the code set, or a set of instructions, when loaded and executed by a processor, causes the process to perform:
acquiring an object to be operated, wherein the object to be operated is image data or sound data;
inputting the object to be operated into a target model, wherein the target model is a trained neural network model and at least one set of parameters in the target model is acquired in a predetermined manner, and the target model is configured to carry out a recognition operation or a processing operation on the object to be operated; in a case that the object to be operated is the image data, the processing operation on the image data carried out by the target model comprises at least one of repairing, beautifying, or adjusting the image data, and the recognition operation on the image data carried out by the target model comprises at least one of recognizing objects, characters, or text in the image data; in a case that the object to be operated is the sound data, the processing operation on the sound data carried out by the target model comprises at least one of adjusting or editing the sound data, and the recognition operation on the sound data carried out by the target model comprises at least one of recognizing voiceprint information or language information in the sound data;
acquiring an operation result output by the target model;
wherein the predetermined manner comprises: acquiring a collection of sample parameters corresponding to a first set of parameters of the target model, the collection of sample parameters comprising a plurality of sets of sample parameters; performing a plurality of iteration processing on the collection of sample parameters; acquiring a target set of parameters based on the collection of sample parameters subjected to the plurality of iteration processing; and determining the target set of parameters as the first set of parameters, one iterative processing comprising: acquiring four pending sets of parameters corresponding to two sets of sample parameters in the collection of sample parameters in a plurality of optimization directions, and replacing one of the two sets of sample parameters by a pending set of parameters with the smallest loss value among the four pending sets of parameters.

16. The computer device according to claim 14, wherein the processor, when loading and executing the at least one instruction, the at least one segment of a program, and the code set, or set of instructions, is caused to perform
acquiring a collection of iterated sample parameters by performing iteration processing on the collection of sample parameters;
performing next iteration processing on the collection of iterated sample parameters in response to not satisfying a preset iteration termination condition; and
acquiring the target set of parameters based on the collection of iterated sample parameters in response to satisfying the preset iteration termination condition.

17. The computer device according to claim 14, wherein the collection of sample parameters comprises m+1 sets of sample parameters, referring as wₙ, wₙ₊₁, wₙ₊₂, wₙ₊₃ . . . wₙ₊ₘ, n being an integer greater than or equal to 0, and m being an integer greater than 2; and
wherein the processor, when loading and executing the at least one instruction, the at least one segment of a program, and the code set, or set of instructions, is caused to perform:
acquiring the four pending sets of parameters by means of preset formulas, the preset formulas comprising:
wₓ=wₙ₊₁+s*(wₙ₊₁−wₙ), s being greater than 0;
wₓ₊₁=wₙ₊₁+2s*(wₙ₊₁−wₙ);
wₓ₊₂=wₙ₊₁+u*(wₙ−wₙ₊₁), u being greater than 0 and less than 1; and
wₓ₊₃=wₙ+s*(wₙ−wₙ₊₁);
where wₓ, wₓ₊₁, wₓ₊₂, and wₓ₊₃ are the four pending sets of parameters, x is an integer greater than 0, and s and u are preset coefficients.

18. The computer device according to claim 17, wherein the processor, when loading and executing the at least one instruction, the at least one segment of a program, and the code set, or set of instructions, is caused to perform:
removing wₙ from the collection of sample parameters and determining wₓ₊₁ as wₙ₊ₘ₊₁ of the collection of sample parameters in response to satisfying a first formula Lₙ>Lₓ, Lₓ≥Lₓ₊₁;
removing wₙ from the collection of sample parameters and determining wₓ as wₙ₊ₘ₊₁ of the collection of sample parameters in response to satisfying a second formula Lₙ>Lₓ, Lₓ<Lₓ₊₁;
removing wₙ from the collection of sample parameters and determining wₓ₊₂ as wₙ₊ₘ₊₁ of the collection of sample parameters in response to satisfying a third formula Lₙ≤Lₓ, Lₓ>Lₓ₊₂; and
removing wₙ from the collection of sample parameters and determining wₓ₊₃ as wₙ₊ₘ₊₁ of the collection of sample parameters in response to not satisfying the first formula, the second formula or the third formula;
where Lₙ is a loss value for wₙ, Lₓ is a loss value for wₓ, Lₓ₊₁ is a loss value for wₓ₊₁, and Lₓ₊₂ is a loss value for wₓ₊₂.

19. The computer device according to claim 16, wherein the processor, when loading and executing the at least one instruction, the at least one segment of a program, and the code set, or set of instructions, is caused to perform:
determining a first set of sample parameters with the smallest loss value in the collection of iterated sample parameters in response to satisfying the preset iteration termination condition;
acquiring a mean set of sample parameters of the plurality of sets of sample parameters in the collection of iterated sample parameters;
determining the first set of sample parameters as the target set of sample parameters in response to the loss value of the first set of sample parameters being less than a loss value of the mean set of sample parameters; and
determining the mean set of sample parameters as the target set of sample parameters in response to the loss value of the first set of sample parameters being greater than the loss value of the mean set of sample parameters.

20. The computer device according to claim 16, wherein the processor, when loading and executing the at least one instruction, the at least one segment of a program, and the code set, or set of instructions, is caused to perform:
determining that the preset iteration termination condition is satisfied in response to a number of times of the iteration processing as performed reaching a specified value; and
determining that the preset iteration termination condition is not satisfied in response to the number of times of the iteration processing as performed not reaching the specified value.

21. The computer device according to claim 16, wherein the processor, when loading and executing the at least one instruction, the at least one segment of a program, and the code set, or set of instructions, is caused to perform:
acquiring a pending set of sample parameters corresponding to the collection of iterated sample parameters, the pending set of sample parameters being a mean set of sample parameters of the plurality of sets of sample parameters in the collection of sample parameters or the pending set of sample parameters being a set of sample parameters with the smallest loss value in the collection of sample parameters;
determining that the preset iteration termination condition is satisfied in response to a loss value of the pending set of sample parameters being less than or equal to a specified loss value; and
determining that the preset iteration termination condition is not satisfied in response to the loss value of the pending set of sample parameters being greater than the specified loss value.

22. The computer device according to claim 16, wherein the processor, when loading and executing the at least one instruction, the at least one segment of a program, and the code set, or set of instructions, is caused to perform:
acquiring a mean set of sample parameters of the plurality of sets of sample parameters in the collection of iterated sample parameters in response to satisfying the preset iteration termination condition; and
determining the mean set of sample parameters as the target set of sample parameters.

23. The computer device according to claim 16, wherein the processor, when loading and executing the at least one instruction, the at least one segment of a program, and the code set, or set of instructions, is caused to perform:
acquiring a first set of sample parameters with the smallest loss value in the collection of iterated sample parameters in response to satisfying the preset iteration termination condition; and
determining the first set of sample parameters as the target set of sample parameters.
